(19) United States
(12) Patent Application Publication
(10) Pub. No.: US 2001/0034844 A1
(43) Pub. Date: Oct. 25, 2001

(54) Method and apparatus for firewall with multiple addresses

(76) Inventor: Steven Michael Bellovin, Westfield, NJ (US)

Correspondence Address: Samuel H. Dworetsky, AT&T CORP., P.O. Box 4110, Middletown, NJ, 07748-4110, US

(21) Appl. No.: 09/771,811

(22) Filed: Jan. 29, 2001

Related U.S. Application Data
(60) Provisional application No. 60/178,981, filed on Jan. 28, 2000.

(51) Int. Cl. H04L 9/00

(52) U.S. Cl. 713/201

(57) ABSTRACT

The invention takes advantage of the capability of assigning multiple addresses to a single host to improve the processing performed by a firewall in a packet-switched network. The host utilizes a plurality of addresses to refer to groups of related tasks on the host. When the firewall receives an outbound packet having one of these source addresses, it authorizes further inbound packets addressed to the particular source address.

### FIELD OF THE INVENTION

The present invention relates generally to security engineering in a telecommunication network, and, more particularly, to the designs of firewall applications in an Internet Protocol (IP) network.

### BACKGROUND OF THE INVENTION

A firewall is a means used pervasively on the Internet today to regulate access to resources on a private network. Firewalls today are offered in a wide range of different architectures and features that enable a firewall administrator to selectively block specific applications from both within and outside the firewall. Unfortunately, firewalls have traditionally faced difficulty when confronted with application protocols that need to open secondary channels, for example and most notably, the File Transfer Protocol (ftp) (see, J. Postel, J. Reynolds, “FILE TRANSFER PROTOCOL (FTP),” IETF Network Working Group, RFC 959, October 1985). Other examples abound, e.g., the remote shell (“rsh”) command, RealAudio, H.323. tftp and the X Windows System. To operate with such popular applications, firewalls have been forced either to follow the application layer protocol and configure themselves appropriately or to keep open—sometimes unnecessarily—a range of ports.

In many such cases, the firewall is doing too much work. Either traffic for a particular service is to be permitted or, often, it is to be blocked entirely. The details of the protocol are important if and only if the decision is made to permit the traffic, in which case detailed knowledge of the protocol is needed by the firewall. Needless to say, this complicates the design of firewalls and makes it harder to deploy new protocols.

### SUMMARY OF THE INVENTION

The invention takes advantage of the capability of assigning multiple addresses to a single host to improve the processing performed by a firewall in a packet-switched network. The host temporarily utilizes a plurality of addresses to refer to groups of related processes on the host. When the firewall receives an outbound packet having one of these source addresses, it authorizes further inbound packets addressed to the particular source address. The firewall advantageously need not know the details of the particular protocol in deciding whether to permit the inbound traffic, e.g. the firewall does not need to look at the port number or the content of the inbound packet. Thus, instead of trying to follow the unfolding application protocol details, the firewall makes an initial permissibility determination based on transport layer protocol and the endpoints' ports and addresses. Assuming approval of the proposed transaction, the firewall can subsequently permit all traffic between the approved address pairs, irrespective of port. Any security concerns arising from the firewall's apparent loss of control over a session's evolving ports can be alleviated by dynamic control of the protected host's active addresses. Further, by segregating and controlling which addresses offer network services outside the firewall and which facilitate protected-host driven network requests, the architecture provides a natural address-based division between potentially hostile requests from outside the bastion, and presumably benign outbound activities originating within the protected network.

These and other advantages of the invention will be apparent to those of ordinary skill in the art by reference to the following detailed description and the accompanying drawings.

### BRIEF DESCRIPTION OF THE DRAWINGS

FIG. 1 is a conceptual diagram of an IP network embodying principles of the invention.

FIG. 2 is a diagram of the structure of an IPv6 address.

FIG. 3 is a flowchart of processing performed by a firewall with regard to outbound packets in accordance with an embodiment of the invention.

FIG. 4 is a flowchart of processing performed by a firewall with regard to inbound packets in accordance with an embodiment of the invention.

### DETAILED DESCRIPTION

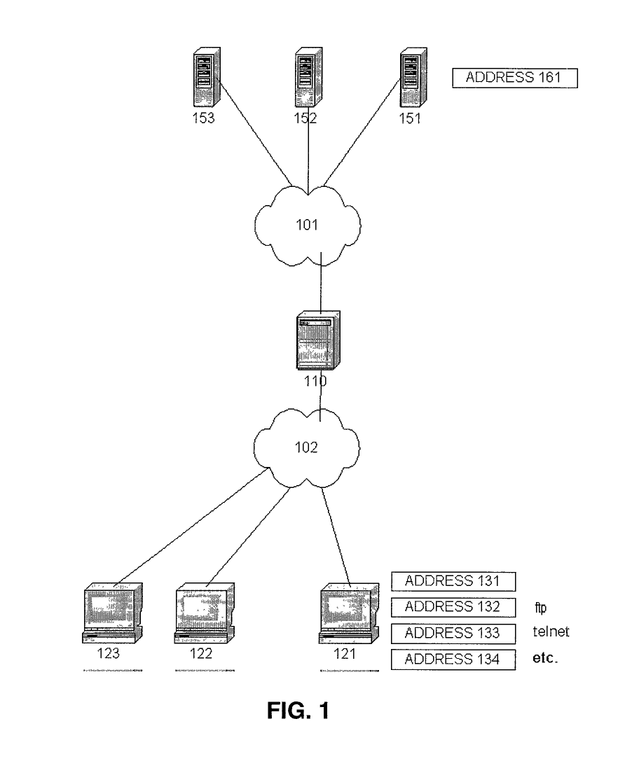

In FIG. 1, illustrating one embodiment of the invention, a firewall 110 separates IP network 101 from “internal” network 102. IP network 101 is a packet-switched data network that routes datagrams addressed to and from hosts, e.g. 151, 152, 153, identified by IP address, as is well known in the art. For example, where the network uses an Internet Protocol version 4 (“IPv4”) addressing scheme, a host, e.g. 151 in FIG. 1, would have a 32-bit address 161 traditionally expressed as a series of four octet values, e.g. 192.193.194.1. See, e.g., “INTERNET PROTOCOL,” IETF Network Working Group, RFC 791 (September 1981), which is incorporated by reference herein. Where the network uses an Internet Protocol version 6 (“IPv6”) addressing scheme, a host would have a 128-bit address. See, e.g. S. Deering, R. Hinden, “Internet Protocol, Version 6 (IPv6) Specification,” IETF Network Working Group, RFC 1883 (December 1995), which is incorporated by reference herein. In accordance with an IETF proposal by the inventor, S. Bellovin, “On Many Addresses per Host,” IETF Network Working Group, RFC 1681 (August 1994), which is incorporated by reference herein, hosts connected to the IP network 101 can utilize and be assigned multiple addresses.

Internal network 102 connects hosts 121, 122, 123 “inside” the firewall to the IP network 101. Internal network 102 may be an IP-based “intranet” or a local area network or any other form of data network that may be interfaced to an IP-based network. Host 121, in accordance with an embodiment of the invention, has a plurality of addresses, shown as 131, 132, 133, 134 in FIG. 1, which it can utilize in accessing IP network 101. One of the addresses, e.g. address 131, would be the “base address” of the host, and would be used to address long-running services. The remaining addresses are assigned to individual “process groups” for transient network activity. A process group is a group of related tasks or processes on the host that act together in some fashion. For example, an FTP session could be assigned an address, e.g. address 132 in FIG. 1, while a telnet session could be assigned another address, e.g. address 133 in FIG. 1, while a second FTP session could be assigned yet another address, e.g. address 134 in FIG. 1, etc. Each process group is assigned a separate IP address the first time the host emits an outbound packet. The host associates packets received with that destination IP address with the particular process/task assigned to the address. Thus, two different process groups engaged in an FTP session would have different IP addresses, even if from the same machine. The data channels associated with such FTP sessions would be bound to those unique IP addresses, and would not use the main address of the host.

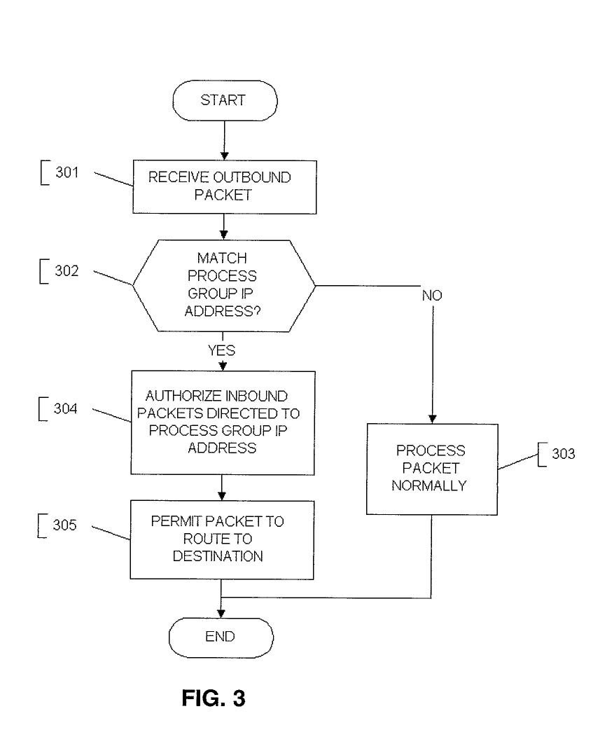

In FIG. 3, a flowchart is shown which illustrates the processing performed by the firewall with regard to an outbound packet, in accordance with an embodiment of the invention. At step 301, the firewall receives the outbound packet and looks at the source and destination addresses of the packet. At step 302, the firewall determines whether the packet's source address matches an authorized process group address. This may entail also checking the outbound port number to ensure that it is in accordance with protocol associated with the particular process group. If the source address does not match an authorized process group address, then the packet is processed as in the prior art by the firewall, either dropping or permitting the packet to continue at step 303. If the source address does match an authorized process group address, at step 304, the firewall authorizes subsequent inbound packets directed to the process group address. At step 305, the firewall then permits the packet to route to the destination address.

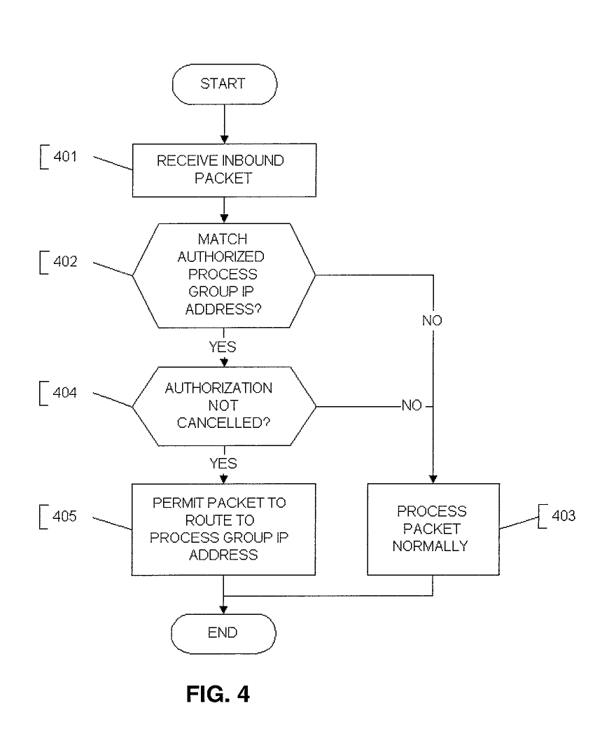

Thus, if a firewall sees an FTP connection request emanating from an authorized “extra” FTP address of a host, it can simply permit any incoming traffic to that address, regardless of port number. In FIG. 4, the firewall receives an inbound packet at step 401 and checks the packet's destination address. If at step 402 the packet matches a process group address, as authorized in FIG. 3, the firewall can permit the packet to route to the process group address (step 405), assuming that authorization has not yet been cancelled (step 404). Otherwise, the packet is processed as in the prior art at step 403. The firewall advantageously need not know the details of the protocol once the process group address has been authorized. All it needs to know is that the protocol type involves secondary channels.

It is desirable that the firewall tear down the authorization for the incoming packets destined for the extra addresses after some period of time reasonably necessary to accomplish the tasks assigned to the process group. There are a number of different ways to implement this, each of which would be encompassed within the invention. For example, where the triggering packet is from a TCP connection, the authorization can be torn down when the TCP connection terminates. Alternatively, a timer-based mechanism can be used, e.g. the process group address is removed from an authorization table some pre-specified number of minutes after that last use of the address. Alternatively, a host can explicitly release authorization when the process group terminates. The host would then not reassign the address to another process group until it received confirmation from the firewall that the authorization had been cancelled. A combination of the above and other mechanisms can be used as well: e.g., such as the use of explicit release coupled with a three-day timeout to avoid exhaustion of firewall resource in case the host has crashed.

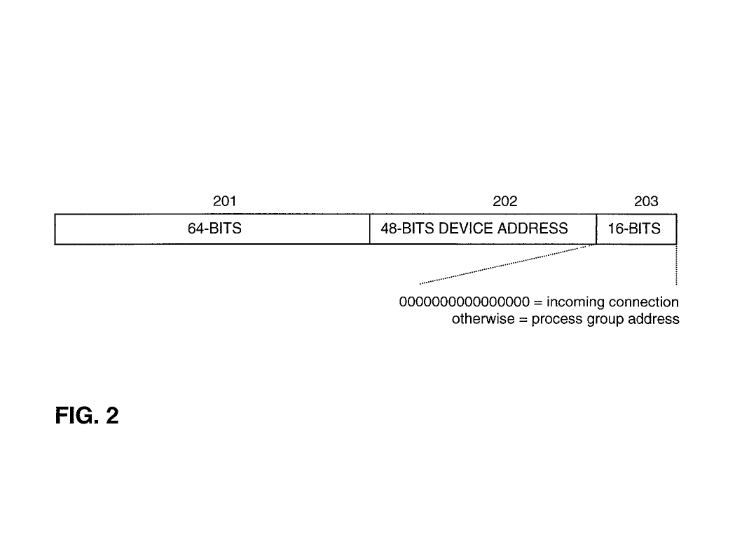

There are a number of different mechanisms that can be used for allocating the extra addresses to a host. Each host can choose an IP address from a pre-assigned pool of addresses. Alternatively, a host can request an IP address using a known address configuration scheme such as the Dynamic Host Configuration Protocol (DHCP). See, R. Droms, “Dynamic Host Configuration Protocol,” IETF Network Working Group, RFC 2131, March 1997, which is incorporated by reference herein. It should be noted that although the invention can be used with IPv4, many sites today on the Internet do not have enough v4 addresses to effectively use the invention. On the other hand, when an addressing scheme such as IPv6 is more widely deployed, a more powerful mechanism of allocating the extra addresses can be utilized. As mentioned above, IPv6 addresses are 128 bits long, as illustrated in FIG. 2. The high order 64 bits, 201 in FIG. 2, are assigned by an administrator and have topological significance, such as identifying a particular local area network. The low-order 64 bits, 202 in FIG. 2, are more-or-less assignable at will by the site administrator. A standard mechanism (See S. Hinden, R. Deering, “IP Version 6 Addressing Architecture,” IETF Network Working Group, RFC 2373, July 1998, which is incorporated by reference herein) suggests using the 48-bit Ethernet (IEEE 802.3) address, with a two-byte specified field inserted in the middle. These remaining 16 bits, 203 in FIG. 1, can be utilized in the context of the present invention without impairing the functionality of the IPv6 address. The Ethernet address (or equivalent) can be used as the left-most 48-bits of this field, leaving the 16 bits to be used for “extra” addresses by each host. It is then useful to reserve the use of a value of all 0s for generic incoming connections to the host, if any. This has several other advantages. First, routers conventionally already use the leading prefix of an address to decide how to route the packet; this mechanism lets the last-hop router use a single table entry with a prefix of 112 bits to send all such packets to a single host. Second, it permits a simple degenerate case of a firewall: block all incoming packets to addresses with 16 low-order bits of all 0's (except for such machines as the mail server), but permit anything to any other host. An alternative to the above that is only slightly more complex is to use certain address ranges (in the high-order section) to denote hosts that conform to this process group convention, and to use older mechanisms for hosts that do not conform.

There is an important advantage of the above scheme in the context of today's packet-switched networks: it is more compatible with emerging security standards. See, e.g., S. Kent, R. Atkinson, “Security Architecture for the Internet Protocol,” ETF Network Working Group, RFC 2401, November 1998 (referred to in the art as “IPsec”), which is incorporated by reference herein. Traditional firewalls cannot easily cope with IPsec-protected packets. They cannot see the port numbers or TCP flags fields and, hence, cannot distinguish between a reply to an outgoing message—in which case it should be allowed in—and a probe to another port, which should be blocked. The present invention permits a host to allow in packets to particular addresses, without regard to port numbers, which avoids the problem entirely.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. For example, the Detailed Description uses a diagram of a conventional firewall in FIG. 1 to illustrate the invention. However, the invention is fully applicable to more exotic types of firewalls such as distributed firewalls. See, e.g. pending utility patent application, “A METHOD AND APPARATUS FOR A DISTRIBUTED FIREWALL,” by the same inventor, Ser. No. 09/343,464, filed on Jun. 30, 1999, which is incorporated by reference herein. There are in fact advantages to utilizing the present invention with a distributed firewall, since the above-described mechanisms avoid having to build too much application-specific information into a host. Distributed firewalls also permit a variation on the above that could use a shorter address scheme (such as IPv4) and use a process identifier (e.g., process id or a process group) as part of the decision mechanism. That is, a process that has sent an outbound packet is eligible for receiving incoming connection requests from the outside. Inbound packets received by another unrelated process are dropped. Thus, the sender's identity, at a much finer granularity than host, is utilized to make the access control decision. Again, this can be accomplished in a manner transparent to the sending application program by using the additional knowledge provided by the process identifier.

What is claimed is:

1. A method of processing packets at a firewall in a packet-switched network comprising:
receiving an outbound packet from a process group network address; and
authorizing subsequent inbound packet traffic destined for the process group network address.

2. The invention of claim 1 further comprising the subsequent step of canceling authorization for subsequent inbound packet traffic destined for the process group network address after a period of time.

3. The invention of claim 2 wherein the outbound packet begins a connection protocol and authorization is canceled after the connection terminates.

4. The invention of claim 1 wherein the addresses are expressed as IPv4 address.

5. The invention of claim 1 wherein the addresses are expressed as IPv6 addresses, wherein a portion of the address is reserved to identify a host process group.

6. A method of processing packets at a host which are destined for a firewall in a packet-switched network comprising the steps of:
assigning a process group network address to a first outbound packet commencing a process;
transmitting the outbound packet to a firewall on its path to its destination in a packet-switched network;
receiving inbound packets addressed to the process group network address; and
receiving and associating inbound packets addressed to the process group network address with the process.

7. The invention of claim 6 wherein the process is a connection across the packet-switched network to another host.

8. The invention of claim 6 further comprising the step of notifying the firewall when the process terminates.

9. The invention of claim 6 wherein the host uses a dynamic host configuration protocol to dynamically assign the process group network address.

10. A computer readable medium containing executable program instructions for performing a method on a firewall connected to a packet-switched network comprising the steps of:
receiving an outbound packet from a process group network address; and
authorizing subsequent inbound packet traffic destined for the process group network address.

11. The invention of claim 10 further comprising the subsequent step of canceling authorization for subsequent inbound packet traffic destined for the process group network address after a period of time.

12. The invention of claim 11 wherein the outbound packet begins a connection protocol and authorization is canceled after the connection terminates.

13. The invention of claim 10 wherein the addresses are expressed as IPv4 address.

14. The invention of claim 10 wherein the addresses are expressed as IPv6 addresses, wherein a portion of the address is reserved to identify a host process group.

15. A computer readable medium containing executable program instructions for performing a method on a host connected to a packet-switched network comprising the steps of:
assigning a process group network address to a first outbound packet commencing a process;
transmitting the outbound packet to a firewall on its path to its destination in a packet-switched network;
receiving inbound packets addressed to the process group network address; and
receiving and associating inbound packets addressed to the process group network address with the process.

16. The invention of claim 15 wherein the process is a connection across the packet-switched network to another host.

17. The invention of claim 15 further comprising the step of notifying the firewall when the process terminates.

18. The invention of claim 15 wherein the host uses a dynamic host configuration protocol to dynamically assign the process group network address.
